(19) United States
(12) Patent Application Publication
(10) Pub. No.: US 2007/0010121 A1
(43) Pub. Date: Jan. 11, 2007

(54) Electrical connector

(75) Inventor: Takahito Haneishi, Tokyo (JP)

Correspondence Address: ABELMAN, FRAYNE & SCHWAB, 666 THIRD AVENUE, 10TH FLOOR, NEW YORK, NY, 10017, US

(73) Assignee: DDK LTD.

(21) Appl. No.: 11/476,184

(22) Filed: Jun. 27, 2006

(30) Foreign Application Priority Data
Jul. 5, 2005 (JP) 2005-196058

(51) Int. Cl. H01R 13/62

(52) U.S. Cl. 439/327

(57) ABSTRACT

An electrical connector for a memory card to be removably inserted thereinto, includes a plurality of contacts having a contact portion to contact the memory card, a housing arranging and holding the contacts and having a fitting opening for inserting the memory card, and pivotally movable locking members at both longitudinal ends of the housing for holding or removing the memory card. Upon the electrical connectors being arranged in parallel with and spaced from one another in their width directions with a pitch of 6 to 8 mm, the housing includes reliefs on its upper side and recesses on its lower side on both sides in its width direction for a soldering iron. The electrical connector can allow a soldering iron to be easily inserted into the spacing between electrical connectors arranged even with a pitch of 6 to 8 mm in width direction without contacting their housings in soldering operation.

### BACKGROUND OF THE INVENTION

This invention relates to an electrical connector for use in electric and electronic appliances such as servers, computers and the like, and more particularly to an electrical connector being easy to effect soldering operation even if electrical connectors are arranged in its width direction with very narrow pitches.

For the exchange of signals (information) between a mother board and a daughter board, a plurality of electrical connectors are fixed to the mother board by soldering or the like, and the daughter board is inserted into one of the connectors. More specifically, the electrical connectors each comprise at least a housing having a fitting opening into which the daughter board is inserted, and contacts arranged in and held by the housing to extend into the fitting opening. The applicant of the present application has already proposed such an electrical connector in Japanese Patent Application Opened No. 2002-94,266 (Patent Literature 1).

Patent Literature 1

According to the Abstract of the Japanese Patent Application Opened No. 2002-94,266, this invention has an object to provide an electrical connector achieving a stable electrical connection irrespective of the weight of a substrate without disconnection of ejector locks upon vibration or impact. Disclosed is an electrical connector including a required number of contacts, a housing holding and fixing the contacts and having guide portions on both longitudinal ends and a fitting opening into which a substrate is inserted, and ejector locks pivotally mounted on the guide portions, respectively, wherein lock protection members are provided on the guide portions, respectively, to prevent engaging portions of the ejector locks from disengaging from anchoring portions of the substrate when the substrate is inserted into the fitting opening, and guide protrusions can guide the lock protection members which are slidably moving. Incidentally, claim 1 recites an electrical connector including a required number of contacts, a housing holding and fixing the contacts and having guide portions on both longitudinal ends and a fitting opening into which a substrate is inserted, and ejector locks pivotally mounted on the guide portions, respectively, wherein lock protection members are provided on the guide portions, respectively, to prevent engaging portions of the ejector locks from disengaging from anchoring portions of the substrate when the substrate is inserted into the fitting opening. Claim 2 recites the electrical connector as set forth in claim 1, in which the lock protection members are slidably mounted on the electrical connector in the direction of its thickness. Claim 3 recites the electrical connector as set forth in claim 1, in which the ejector locks are each provided on both sides in its width direction with anchoring grooves, and the lock protection members are each provided on the insides in its width direction with engaging protrusions so that the engaging protrusions of the lock protection members engage the anchoring grooves of the ejector locks when the substrate is inserted to be engaged in the ejector locks. Claim 4 recites the electrical connector as set forth in claim 2, in which the lock protection members are each provided on both the right and left sides with guide projections A and B, and when the lock protection members are slidably moved, they are guided by means of the guide projections. Claim 5 recites the electrical connector as set forth in claim 4, in which the lock protection members are each provided with a protrusion on the side of the substrate inserting direction of the guide projection B, thereby enhancing the holding for the ejector locks in their pivotal direction by means of the protrusions.

In recent years, the quantities of information to be exchanged have been increased to increase electrical connectors to be used, while the miniaturization of information appliances and substrates has also progressed so that occupied areas of the substrates have been limited. Consequently, pitches for arranging the electrical connectors have become narrower so that the electrical connectors have been arranged even with a pitch of 6.0 to 8.0 mm in their width directions. Such electrical connectors are soldered to a mother board by reflow soldering. After the connectors have been soldered to the mother board, it is often required to repair the soldered portions, if defective soldering or failed electrical connection occurs. However, when a soldering iron is inserted into the spacing between the connectors arranged with the pitch of 6.0 to 8.0 mm, it is very difficult to insert the soldering iron into such a close spacing without causing the soldering iron to touch the housing. If the soldering iron touches the housing, the housing tends to melt owing to high temperatures of the soldering iron. If the housing is partly melted, connectors after being mounted must be replaced with new electrical connectors.

### SUMMARY OF THE INVENTION

It is an object of the invention to provide an electrical connector which overcomes all the disadvantages of the prior art and which can allow a soldering iron to be easily inserted into a spacing between electrical connectors arranged even with a pitch of 6.0 to 8.0 mm in width direction without contacting their housings in soldering operation.

The above object can be achieved by an electrical connector 10 for a memory card 60 to be removably inserted thereinto, including a plurality of contacts 14 having a contact portion 28 adapted to contact the memory card 60, a housing 12 arranging and holding the contacts 14 and having a fitting opening 18 into which the memory card 60 is inserted, and pivotally movable locking members 16 arranged at both longitudinal ends of the housing 12 for holding or removing the memory card 60, wherein upon the electrical connectors 10 being arranged in parallel with and spaced from one another in their width directions with a pitch of 6.0 to 8.0 mm, the housing 12 is provided with reliefs 20 on its upper side on both sides in its width direction for a soldering iron and provided with recesses 22 on its lower side on both sides in the width direction.

In one embodiment, as the reliefs 20, outwardly inclined slopes are formed. In a preferred embodiment, longitudinal sizes of the slopes and the recesses 22 are just as long as or longer than longitudinally extending pitches of the contacts 14. Moreover, the locking members 16 are each provided with substantially trapezoidal protrusions 32 extending 0.1 to 0.5 m in its width direction.

As can be seen from the above descriptions, the card connector 10 according to the invention can bring about the following significant functions and effects.

(1) In the electrical connector 10 for a memory card 60 to be removably inserted thereinto, including a plurality of contacts 14 having a contact portion 28 adapted to contact the memory card 60, a housing 12 arranging and holding the contacts 14 and having a fitting opening 18 into which the memory card 60 is inserted, and pivotally movable locking members 16 arranged at both longitudinal ends of the housing 12 for holding or removing the memory card 60, according to the invention, upon the electrical connectors 10 being arranged in parallel with and spaced from one another in their width directions with a pitch of 6.0 to 8.0 mm, the housing 12 is provided with reliefs 20 on its upper side on both sides in its width direction for a soldering iron and provided with recesses 22 on its lower side on both sides in the width direction. Therefore, a soldering iron can be easily inserted into the spacing between the electrical connectors arranged with a pitch of 6.0 to 8.0 mm without touching the housing 12, thereby enabling the soldered portions to be repaired with ease.

(2) According to the invention, as the reliefs 20, the outwardly inclined slopes are formed. Consequently, a soldering iron can be easily inserted into the close spacing without touching the housing 12.

(3) According to the invention, the longitudinal sizes of the slopes and the recesses 22 are just as long as or longer than the longitudinally extending pitches of the contacts 14. Therefore, the soldered portions can be easily corrected (adjusted) without touching the housing 12.

(4) According to the invention, the locking members 16 are each provided with substantially trapezoidal protrusions 32 extending 0.1 to 0.5 mm in the width direction. Consequently, a memory card 60 can be easily inserted into and removed from the connector.

(5) According to the invention, the housings 12 are each provided with recesses 22 on the lower side on the both sides in the width direction. As the thickness of the housing 12 becomes thinner by providing the recesses 22, the dielectric constant of the housing 12 becomes lower so that it becomes easy to set the characteristic impedance to a target value and further to achieve the weight saving of the connectors.

The invention will be more fully understood by referring to the following detailed specification and claims taken in connection with the appended drawings.

### BRIEF DESCRIPTION OF THE DRAWINGS

FIG. 1A is a perspective view of an electrical connector according to the invention viewed from the fitting side;

FIG. 1B is a perspective view of an electrical connector according to the invention viewed from the connection side;

FIG. 2A is a perspective view of the electrical connector according to the invention with a memory card inserted;

FIG. 2B is a perspective view of the electrical connector according to the invention and the memory card which has not been inserted;

FIG. 3A is a perspective view of a plurality of the electrical connectors according to the invention arranged in parallel with one another in their width direction;

FIG. 3B is a cross-sectional view of the electrical connectors in the state shown in FIG. 3A taken along certain contacts;

FIG. 4 is a perspective view of the electrical connector according to the invention with one of the locking members removed;

FIG. 5A is an enlarged perspective view of the proximity of the centers of the electrical connectors; and

FIG. 5B is an enlarged plan view of the proximity of the centers of the electrical connectors.

### DESCRIPTION OF THE PREFERRED EMBODIMENTS

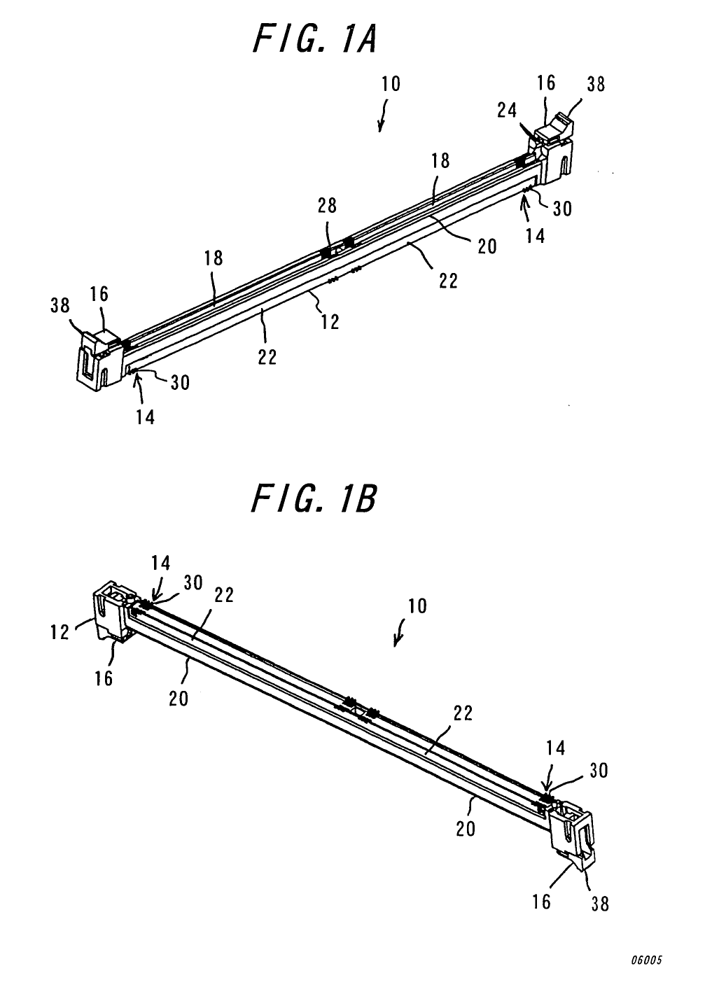

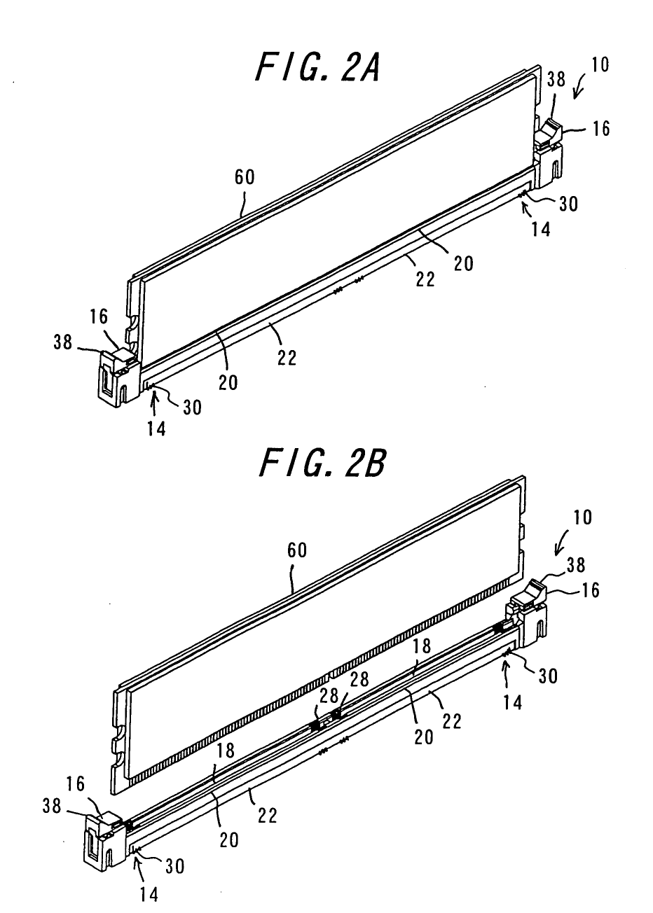

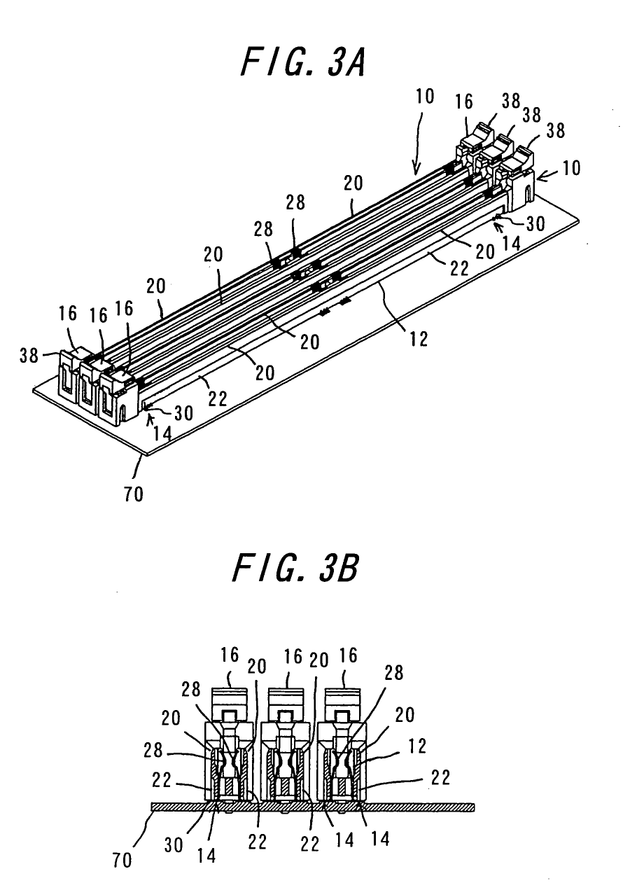

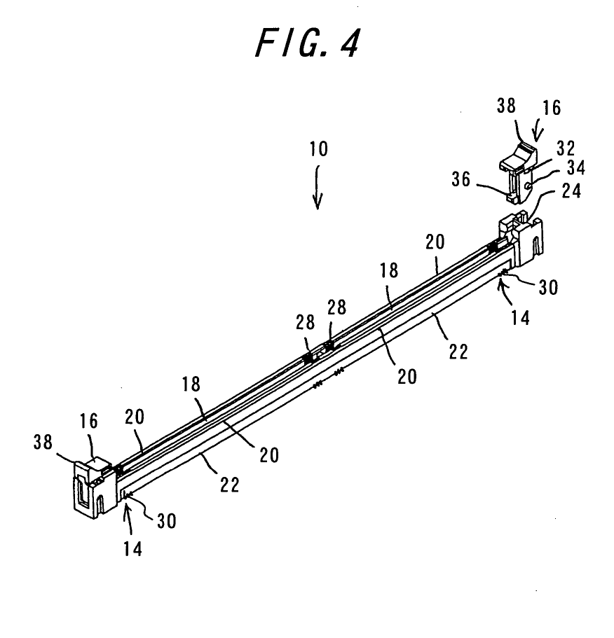

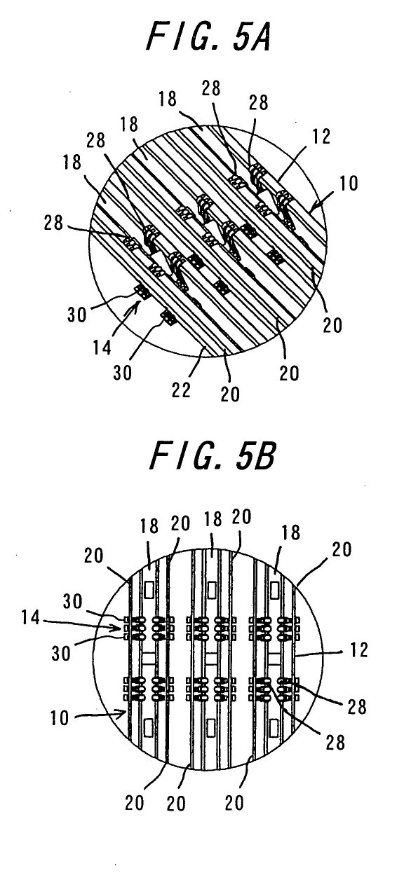

One embodiment of the invention will be explained with reference to FIGS. 1A to 4. FIG. 1A is a perspective view of the electrical connector according to the invention viewed from the fitting side. FIG. 1B is a perspective view of the electrical connector according to the invention viewed from the connection side. FIG. 2A is a perspective view of the connector according to the invention with a memory card inserted. FIG. 2B is a perspective view of the electrical connector and a memory card not yet inserted. FIG. 3A is a perspective view of a plurality of connectors according to the invention arranged side by side in the width direction. FIG. 3B is a sectional view of the connectors of FIG. 3A taken along certain contacts. FIG. 4 is a perspective view of the connector with one locking member removed. FIG. 5A is an enlarged perspective view of the proximity of the centers of the connectors. FIG. 5B is an enlarged plan view of the proximity of the centers of the connectors.

The electrical connector 10 according to the invention mainly comprises a plurality of contacts 14, a housing 12, and locking members 16.

Before explaining components, a memory card (daughter board) 60 will be explained. The memory card 60 is for use in a personal computer, server, printer, or the like, and mainly comprises contact portions adapted to be in contact with contact portions 28 of the contacts 14, patterns for connecting the contact portions and circuits, and connection portions connecting to integrated circuits and central processing unit (CPU) mounted on the patterns. Said memory card 60 for use with the electrical connector 10 according to the invention may be a DIMM (dual inline memory module) memory card, a SO-DIMM (Small Outline-dual inline memory module) memory card, an exclusive memory card or the like. For the card connector 10 of the present embodiment, a DIMM memory card is used.

First, the housing 12 will be explained, which is a subject feature of the invention. Said housing 12 is formed from an electrically insulating plastic material by means of the injection molding of the known technique. The materials for the housing 12 may be suitably selected in consideration of dimensional stability, workability, manufacturing cost and the like. The materials for the housing 12 generally include polybutylene terephthalate (PBT), polyamide (66PA or 46PA), liquid crystal polymer (LCP), polycarbonate (PC) and the like and combination thereof. The housing 12 is provided with a fitting opening 18 into which the memory card 60 is inserted, and with inserting openings 24 into which the locking members are inserted and mounted, respectively. The size of the fitting opening 18 may be so suitably designed that a required number of memory cards 60 can be inserted, and the inserted memory cards can contact two contacts 14 facing to each other. The size of the inserting openings 24 may be so suitably designed that the locking members can be inserted into the inserting openings 24 and can be pivotally moved therein, respectively.

The housing 12 is further provided with inserting holes 26 for arranging and holding the contacts 14 therein. The size of the inserting holes 26 may be so suitably designed that the contacts 14 can be held, and the contact portions 28 of the contacts 14 can extend into the fitting opening 18 so as to contact the memory card 60 with a constant contact force.

Said housing 12 is provided in each of the inserting openings 24 with bearings adapted to engage shafts 34 of the locking member 16, thereby enabling pivotal movement of the locking member 16.

In the case that electrical connectors 10 are arranged on the housing 12 in parallel with one another with a pitch of 6.0 to 8.0 mm as shown in FIGS. 3A and 3B, reliefs 20 are provided in the housing 12 on the side of the fitting opening 18 for avoiding contact of a soldering iron. The reliefs 20 serve to prevent the soldering iron from touching the housing 12 in repairing soldered portions of the electrical connectors 10 when defective soldering or failed electrical connection occurs. The reliefs 20 may be C-shaped or R-shaped chamfers or inclined surfaces or slopes so long as they can fulfil their function. As the reliefs 20 are larger, the reliefs are more effective for the electrical connectors being arranged with such a narrow pitch of 6.0 to 8.0 mm. The reliefs are preferably inclined surfaces because of their function and the strength of the housing 12. For this reason, outwardly inclined slopes are formed for the reliefs in the present embodiment.

Moreover, said housing 12 is provided with recesses 22 on both the sides in the width direction on the connection side (on the opposite side of the fitting opening 18) for avoiding a soldering iron from touching the housing in repairing the soldered portions of the electrical connectors 10 when defective soldering or failed electrical connection occurs. As said recesses 22 serve to prevent a soldering iron from touching the housing 12, the recesses may be provided per the contacts 14, but are provided over all and substantially as long as the pitches of the contacts extending in the longitudinal direction in the present embodiment in consideration of soldability in repairing soldered portions and weight saving. The thickness of the housing 12 becomes thinner by providing the recesses 22 so that the dielectric constant becomes lower, with the result that it becomes easy to set the characteristic impedance to a target value.

The housing 12 is further provided at both the longitudinal ends with positioning bosses different in size from each other for positioning the connector 10 and determining its orientation relative to the substrate 70 when the connector 10 is soldered to the substrate 70.

The locking members 16 will then be explained. Similarly to the housing 12, the locking members 16 are formed from an electrically insulating plastic material by means of the injection molding of the known technique. The materials for the locking members 16 may be suitably selected in consideration of dimensional stability, workability, manufacturing cost and the like. The materials for the housing 12 generally include polybutylene terephthalate (PBT), polyamide (66PA or 46PA), liquid crystal polymer (LCP), polycarbonate (PC) and the like and combination thereof. The locking members 16 are arranged at both the longitudinal ends or one locking member 16 only is arranged at any one end. The locking members 16 serve to remove the memory card 60 from the connector 10. The locking member 16 comprises at least an actuating portion 38, a pushing-up portion 36 for pushing up the memory card 60, and the shafts 34.

The locking member 16 is provided with substantially trapezoidal protrusions 32 which extend 0.1 to 0.5 mm in the width direction. The protrusions 32 provide a stable holding force for the memory card 60 when it has been inserted into the electrical connector 10. If the extending distance of the protrusions 32 is less than 0.1 mm, the holding force is low, while if more than 0.5 mm, the holding force is too high which would make it impossible to pivotally move the locking member 16 manually. By forming the protrusions 32 to be trapezoidal as in the embodiment, it becomes easy to hold the locking member 16. The shape of the protrusions 32 may be suitably designed in consideration of the holding force, ease of pivotal movement, and the like.

The shape of the pushing-up portions 36 is so configured as to embrace the memory card 60 and be in contact with the bottom of the memory card 60. The shape of the pushing-up portions 36 may be of any shape capable of pushing up the memory card and may be suitably designed in consideration of the strength of the locking members 16. The actuating portion 38 may be suitably designed so as to be able to pivotally move the locking member 16 manually.

Finally, a plurality of contacts 14 will be explained. The contacts 14 are made of a metal and formed by means of the press-working of the known technique. Preferred metals from which to form the contacts 14 include brass, beryllium copper, phosphor bronze and the like which comply with the requirements such as springiness, electric conductivity, dimensional stability and the like.

The contact 14 comprises at least a contact portion 28 adapted to contact the memory card 60, a fixed portion to be fixed to the housing 12, and a connection portion 30 to be connected to the substrate. The contact portion 28 has a curved shape in order to be easy to contact the memory card 60. Although the connection portion 30 of the contact 14 is of a surface mounting type (SMT) in consideration of the circuit design of the substrate in the illustrated embodiment, it may be of a dip type. The contacts 14 are arranged in parallel with one another such that two contact portions face to each other and the memory card 60 is embraced between the two opposite contacts 14. The contacts 14 are fixed to the housing 12 by means of press-fitting, hooking (lancing), welding or the like.

The examples of the applications of the invention are electrical connectors for use in electric and electronic appliances such as servers, computers and the like, and particularly electrical connectors being easy to effect soldering operation even if the electrical conductors are arranged in width directions with very narrow pitches.

While the invention has been particularly shown and described with reference to the preferred embodiments thereof, it will be understood by those skilled in the art that the foregoing and other changes in form and details can be made therein without departing from the spirit and scope of the invention.

1-4. (canceled)

5. An electrical connector for removably retaining a memory card that includes a housing containing a plurality of longitudinally-spaced contacts, the housing having a longitudinally extending slot of uniform width for receiving said memory card, said slot defined by a pair of opposed lateral sidewalls, each sidewall having an external contoured surface extending from the base of the housing, the width of the base of the housing being narrower than the width of the upper portion of said housing.

6. The electrical connector of claim 1, wherein the contoured surface slopes inwardly from said upper portion to the lower portion.

7. The electrical connector of claim 2, wherein the narrow base portion defined by the opposed lateral sidewalls is at least co-extensive with said contacts.

8. The electrical connector of claim 5 which includes pivotally movable locking members arranged at opposing ends of the housing for releasably securing the memory card in the slot.

9. The electrical connector of claim 8, wherein said locking members are provided with trapezoidal protrusions having a width of from 0.1 to 0.5 mm.

10. The electrical connector of claim 6 which includes pivotally movable locking members arranged at opposing ends of the housing for releasably securing the memory card in the slot, wherein said locking members are provided with trapezoidal protrusions having a width of from 0.1 to 0.5 mm.

11. The electrical connector of claim 3 which includes pivotally movable locking members arranged at opposing ends of the housing for releasably securing the memory card in the slot, wherein said locking members are provided with trapezoidal protrusions having a width of from 0.1 to 0.5 mm.

12. The electrical connector of claim 5, wherein the upper portion and lower portion of each sidewall are parallel.

13. The electrical connector of claim 5, wherein the lower portion of the sidewall extends vertically from the base and is inset from the upper portion of the sidewall.

14. The electrical connector of claim 5, wherein the lower portion of the sidewall extends at an angle to intersect the upper portion of the sidewall.

15. The electrical connector of claim 5, wherein the upper and lower portions are joined to form a planar sidewall.

16. An assembly comprising a plurality of electrical connectors in accordance with claim 1 arranged in parallel relation and spaced apart from one another at a distance of from about 6 mm to 8 mm as measured between the upper portions of adjacent housing sidewalls, to thereby permit a soldering iron to be introduced into the region between the bases of the adjacent connectors in order to complete solder connections of one or more contacts to a substrate on which the connectors are mounted

17. The electrical connector assembly of claim 16, wherein the upper portion and lower portion of each sidewall are parallel.

18. The electrical connector assembly of claim 16, wherein the lower portion of the sidewall extends vertically from the base and is inset from the upper portion of the sidewall.

19. The electrical connector assembly of claim 16, wherein the lower portion of the sidewall extends at an angle to intersect the upper portion of the sidewall.

20. The electrical connector assembly of claim 16, wherein the upper and lower portions are joined to form a planar sidewall.
